(19) United States
(12) Patent Application Publication
(10) Pub. No.: US 2013/0178582 A1
(43) Pub. Date: Jul. 11, 2013

(54) COATED PARTS AND USE THEREOF

(71) Applicant: Jens Krause, Leverkusen (DE)

(72) Inventor: Jens Krause, Leverkusen (DE)

(73) Assignee: BAYER INTELLECTUAL PROPERTY GMBH, Monheim (DE)

(21) Appl. No.: 13/805,861

(22) PCT Filed: Jun. 20, 2011
(86) PCT No.: PCT/EP2011/060216

§ 371 Date: Mar. 7, 2013

(30) Foreign Application Priority Data
Jun. 24, 2010 (EP) 10305677.6

(51) Int. Cl. C09D 5/16

(52) U.S. Cl. CPC C09D 5/1662
USPC 524/590

(57) ABSTRACT

The invention relates to parts coated with polyurethane and to the use thereof, preferably in the sea.

The invention relates to parts coated with polyurethanes and to their use preferably in the sea.

In the insulation of parts/elements such as pipes, connecting elements, conveying systems, particularly in deep-sea pipes, polyurethanes are employed. The coating in this case may on the one hand be applied directly to the element to be coated (by casting, for example), as is carried out in the case of field joints. Alternatively, coating may also take place indirectly, with the coating being produced separately, and then applied to the element that is to be insulated, by screw connection, for example. This variant is carried out in the case, for example, of bend restrictors. These elements are used, for example, to convey oil and gas, with the polyurethane constituting an insulating coating. These polyurethanes are normally solid or syntactic. The term “syntactic polymers” generally encompasses plastics which comprise hollow fillers. In this context there are both hollow-glass fillers and hollow polymeric fillers. In the majority of cases the fillers are hollow glass beads. Syntactic polymers find use typically, on the basis of their advantageous compressive strength and temperature stability, as thermal insulation coatings, preferably in the offshore sector. Other applications in the offshore sector are bend stiffeners, bend restrictors, buoys, clamp systems, cables, flow traversal systems, and ballast tanks, and also X-trees. With the exploration of increasingly deeper oilfields, the requirements imposed on the coatings are rising. Nowadays, materials are sought which on the one hand are elastic, in order to allow the elements to be easily deformed, for example; on the other hand, coatings with high temperature stability are sought, which resist hydrolysis by the water. In use nowadays, besides other plastics, such as polypropylene, for example, are exclusively solid or syntactic, unfoamed polyurethane elastomers, in some cases reinforced with epoxy resins. These systems possess both sufficient elasticity and temperature stability. However, the current polyurethane elastomers exhibit very poor resistance to hydrolysis at temperatures above 50° C. Since present-day coatings are in use for up to 20 years and a temperature stability of >80° C., in some cases even >100° C., is required, the polyurethanes in use at present are inadequate. In many cases, therefore, polypropylene materials are used, but have the disadvantage that they cannot be applied in situ, i.e., on a boat, for example. The injection molding operation which has to be carried out is also much too costly and inconvenient. Another disadvantage is that at very low temperatures, these plastics become brittle and shatter like glass. A further disadvantage is that many applications require the casting of complex geometries, where the injection technology/thermoplastic processing cannot be employed.

The object, therefore, was to provide a system which
a) can be processed in a simple casting process,
b) can be processed in situ as—as far as possible—a two-component reaction mixture,
c) as far as possible, neither contains nor gives off toxic substances,
d) can be processed at room temperature,
e) as far as possible, has a processing life of <5 minutes, with the elastomer being elastic and having a hardness of >50 Shore A or >20 Shore C after 10 minutes' demolding,
f) can be produced easily and quickly,
g) exhibits good aging at high temperatures in water,
h) exhibits a maximum elongation at break of >30%,
i) has a hardness of >85 Shore A and <85 Shore D.

This object has surprisingly been achieved through the combination of certain high-functionality, long-chain polyols with certain modified polyisocyanates based on diphenylmethane diisocyanate (MDI).

The present invention accordingly provides coated parts coated with polyurethanes, the polyurethanes,
in the presence of at least one metal catalyst from the group consisting of mercury, cobalt, hafnium, aluminum, cadmium, lead, iron, tin, zinc, bismuth, zirconium, and titanium catalysts, and blends thereof, being obtainable from:
a) at least one polyisocyanate based on diphenylmethane diisocyanate (MDI) and having an NCO content of 18% to 34% by weight, a fraction of not more than 20% by weight, based on polyisocyanate a) employed, of 2,4′-MDI isomer and a fraction of at least 5% by weight, based on polyisocyanate a) employed, of diphenylmethane diisocyanate modified with carbodiimide groups and with uretonimine groups, and being liquid above 30° C.,
b) at least one ethylene oxide and/or propylene oxide based polyether polyol having a functionality of 5 to 8, preferably of 6 to 7, an OH number of 5 to 45 mg KOH/g solids, and an ethylene oxide units content of 0% to 50% by weight,
c) at least one chain extender having a molecular weight of 62 to 500 g/mol and a functionality of 2 to 3,
d) 2% to 15% by weight, based on components b) to e), of at least one epoxy resin having a number-average molecular weight of 10000 g/mol,
e) 0% to 50% by weight, based on components b) to e), of polyols from the group consisting of ethylene oxide and/or propylene oxide based polyethers having an OH number of 50 to 400 mg KOH/g solids, a functionality of 5 to 7, and an ethylene oxide units content of 0% to 50% by weight, ethylene oxide and/or propylene oxide based polyethers having an OH number of 20 to 200 mg KOH/g solids, a functionality of ≧2 to <5, and an ethylene oxide units content of 0% to 50% by weight, polyols having a functionality of 2 and based on polytetramethylene glycols having a molecular weight of 600 to 3000 g/mol, OH-terminated polybutanedienes, polycarbonate diols, and blends thereof,
f) optionally UV stabilizers and oxidation stabilizers,
g) optionally auxiliaries and/or additives, and
h) optionally adhesion promoters,
the ratio of NCO groups to NCO-reactive groups in components b), c), and e) being from 0.70 to 1.30, preferably from 0.85:1 to 1.2:1, more preferably from 0.95:1 to 1.1:1.

By diphenylmethane diisocyanate (MDI) in this patent application is meant the isomers, more particularly 4,4′-MDI, 2,4′-MDI, 2,2′-MDI, and blends thereof (“monomeric MDI” [“mMDI”]) and polymeric constituents (“polymeric MDI” [“pMDI”]), and also mixtures of mMDI with pMDI (also referred to generally as technical MDI). It is particularly preferred, however, to use an MDI without polymeric constituents (mMDI).

The amount of 2,4′-MDI in component a) is preferably below 10% by weight, more preferably below 5% by weight, based on polyisocyanate.

The amount of diphenylmethane diisocyanate modified with carbodiimide groups and uretonimine groups is preferably at least 20% by weight and not more than 100% by weight, based on polyisocyanate a) employed.

Modification of the MDI is in principle a reaction of the NCO group of the MDI. The formation of a prepolymer is a special case of a modification, and relates to the reaction of a compound containing NCO reactive groups with the NCO groups of the MDI.

In one particularly preferred embodiment, the polyisocyanate a) employed is obtained by reaction of diphenylmethane diisocyanate (MDI) with a polyether polyol based on ethylene oxide and/or propylene oxide or polytetramethylene glycol.

The NCO content of the polyisocyanate component a) is preferably between 23% and 30% by weight.

It is an advantage that the isocyanate component has a high NCO content (in other words, for example, a low level of modification), possesses a low viscosity, and at the same time remains liquid and does not crystallize, even at low temperatures.

Products which are liquid at room temperature, with a viscosity of 2000 mPa·s at 25° C., are preferred. This usually corresponds to an NCO content of >20%.

In order to prevent crystallization of any free MDI still present in the MDI prepolymers, it is possible to add polycyclic MDI (also known by the term “polymeric MDI”) to the prepolymer. It is preferred, however, not to use any polymeric MDI.

Component b) is used preferably in an amount of at least 30% by weight and not more than 85% by weight, based on components b) to e), more preferably of 40% to 85% by weight, very preferably of 55% to 80% by weight. The ethylene oxide content is preferably 5% to 35% by weight.

Component e) is used preferably in an amount of at least 0.5% by weight and not more than 40% by weight, based on components b) to e), more preferably of 0.5% to 20% by weight, preferably of 1% to 12% by weight, and very preferably of 3% to 12% by weight.

Polyether polyols which can be used as component b) or e) are prepared either by means of alkaline catalysis or by means of double metal cyanide catalysis or, optionally, in the case of a staged reaction regime, by means of alkaline catalysis and double metal cyanide catalysis, from a starter molecule and epoxides, preferably ethylene oxide (EO) and/or propylene oxide (PO), and have terminal hydroxyl groups and/or amino groups. Starters contemplated in this context include the compounds known to the skilled person that have hydroxyl groups and/or amino groups, and also water. The functionality of the starters here is at least 2 and not more than 8. It is of course also possible to use mixtures of two or more starters. Furthermore, mixtures of two or more polyether polyols can be used as polyether polyols. As a polyol component it is preferred to use polyether polyols, more preferably polyoxypropylene polyols and/or polyoxyethylene polyols. As polyols for preparing the polyisocyanate it is also possible, additionally, to use low molecular weight oligomers based on EO and/or PO, such as, for instance, dipropylene glycol, tripropylene glycol or the like.

In process engineering terms it is advantageous for the volume flow of the isocyanate component a) and the volume flow of the NCO-reactive components b), c), and e) to be similar in magnitude.

Chain extenders used (also called crosslinkers) are compounds having a functionality of 2 to 3 and a molecular weight of 62 to 500 g/mol. The chain extender is used preferably in an amount of at least 5% by weight and not more than 35% by weight, based on components b) to e), more preferably of 12% to 25% by weight. Use may be made of aromatic aminic chain extenders, such as, for example, diethyltoluenediamine (DETDA), 3,3′-dichloro-4,4′-diaminodiphenylmethane (MBOCA), 3,5-diamino-4-chloroisobutyl benzoate, 4-methyl-2,6-bis(methylthio)-1,3-diaminobenzene (Ethacure 300), trimethylene glycol di-p-aminobenzoate (Polacure 740M), 4,4′-diaminodiphenylmethane (MDA), and also complexes thereof with salts, such as, for example sodium chloride and/or lithium chloride, and 4,4′-diamino-2,2′-dichloro-5,5′-diethyldiphenylmethane (MCDEA). Preferred are MBOCA and 3,5-diamino-4-chloroisobutyl benzoate. Aliphatic aminic chain extenders may likewise be used, exclusively or additionally. They often have a thixotropic effect on account of their high reactivity. Nonaminic chain extenders often used are, for example, 2,2′-thiodiethanol, propane-1,2-diol, propane-1,3-diol, glycerol, butane-2,3-diol, butane-1,3-diol, butane-1,4-diol, 2-methylpropane-1,3-diol, pentane-1,2-diol, pentane-1,3-diol, pentane-1,4-diol, pentane-1,5-diol, 2,2-dimethylpropane-1,3-diol, 2-methylbutane-1,4-diol, 2-methylbutane-1,3-diol, 1,1,1-trimethylolethane, 3-methyl-1,5-pentanediol, 1,1,1-trimethylolpropane, 1,6-hexanediol, 1,7-heptanediol, 2-ethyl-1,6-hexanediol, 1,8-octanediol, 1,9-nonanediol, 1,10-decanediol, 1,11-undecanediol, 1,12-dodecanediol, diethylene glycol, triethylene glycol, 1,4-cyclohexanediol, 1,3-cyclohexanediol, and water. It is especially preferred to use nonaminic chain crosslinkers. Especially preferred is the use of OH-functional crosslinkers having a functionality of 2. The preferred crosslinker is 1,4-butanediol.

As epoxy resin it is possible for example to use reaction products of epichlorohydrin with bisphenol A or bisphenol F. The number-average molecular weight of the reaction product is preferably less than 10 000 g/mol, more preferably less than 1000 g/mol.

The sum total of components b) to e) is 100% by weight.

The catalysts are metal-containing catalysts, such as, for example, Lewis acid compounds, based for example on tin, lead, hafnium, cobalt, zinc, titanium, zirconium, but also cadmium, bismuth (for example, bismuth neodecanoate), and iron. An overview of the prior art is given in WO 2005/058996. There it is described how work is carried out with titanium catalysts and zirconium catalysts. Also mentioned are numerous possibilities for combination of different catalysts. Catalyst systems which are at least less toxic than mercury catalysts, based for example on tin, zinc, bismuth, titanium or zirconium, are likewise known in the market and used with preference. Currently the most common catalyst is a mercury phenyl neodecanoate, Thorcat 535 (from Thor Especialidades S.A.). Very preferably, however, tin catalysts are used, examples being dioctyltin di(2-ethylhexanoate), dioctyltin dimercaptide, dioctyltin dilaurate (DOTL), dibutyltin dilaurate (DBTL), dibutyltin dicarboxylate, butyltin tris(2-ethylhexanoate), dibutyltin dineodecanoate, dioctyltin dicetanoate, dibutyltin dicetanoate, dioctyltin diacetate, dibutyltin diacetate (DBTA), dibutyltin diacetate, dibutyltin maleate, dibutyltin dichloride, dibutyltin sulfide, dibutyltin oxide (DBTO), dibutyltin bisoctylmaleinate, dibutyl bis(dodecylthio)stannates, dioctyltin-dicarboxylate, with very particular preference being given to the use of DBTL and/or dioctyltin dimercaptide. It is of course also possible to use the catalysts in combination with one another.

Common catalysts are available from, for example, Tosoh Chemicals, Air Products, TIB Chemicals AG, Goldschmidt, and Johnson Matthey.

The auxiliaries and/or additives are, for example, dyes, fillers (such as lime, for example), silicone additives, zeolite pastes, flow improvers, and hydrolysis inhibitors.

In one specific embodiment it is possible as additives to use hollow microbeads, if syntactic polyurethanes are to be produced.

The term “hollow microbeads” refers in the context of this invention to hollow organic and mineral beads. Hollow organic beads which can be used include, for example, hollow polymeric beads, made from polyethylene, polypropylene, polyurethane, polystyrene or a mixture thereof, for example. Hollow mineral beads may be produced, for example, from clay, aluminum silicate, glass or mixtures thereof. In their interior the hollow beads may have a vacuum or partial vacuum, or may be filled with air, inert gases, such as nitrogen, helium or argon, for example, or reactive gases, such as oxygen, for example. The hollow organic or mineral beads preferably have a diameter of 1 to 1000 mm, preferably of 5 to 200 mm. The hollow organic or mineral beads preferably have a bulk density of 0.1 to 0.4 g/cm3. They generally possess a thermal conductivity of 0.03 to 0.12 W/mK. As hollow microbeads it is preferred to use hollow glass microbeads. In one particularly preferred embodiment the hollow glass microbeads have a hydrostatic compressive strength of at least 20 bar. As hollow glass microbeads it is possible, for example, to use 3M Scotchlite® Glass Bubbles. As polymer-based hollow microbeads it is possible, for example, to use Expancel products from Akzo Nobel.

Polycarbonate diols are obtained in accordance with the prior art from carbonic acid derivatives, as for example dimethyl carbonate or diphenyl carbonate or phosgene, and from polyols, by means of polycondensation.

It is preferred for the isocyanate component and for the compound containing the NCO reactive groups not to contain any physical blowing agent. It is further preferred for no water to be added to these components. The components more preferably comprise, accordingly, no blowing agent, apart from minimum amounts of residual water contained within industrially produced polyols. It is preferred to reduce the residual water content by adding water scavengers. Examples of suitable water scavengers include zeolites. The water scavengers are used for example in an amount of 0.1% to 10% by weight, based on the total weight of the compound containing the NCO reactive groups. The mixing of the NCO and OH reactive components may take place using the customary PUR processing machines. In one preferred embodiment the mixing is accomplished by low-pressure machines or high-pressure machines, more preferably low-pressure machines.

In the production of the parts of the invention it is preferred to use low-pressure casting machines with dynamic and static mixers, particular preference being given to the use of machines with an output of >10 kg/min and, preferably, of static mixers.

The polyurethane may be applied (by casting, for example) in one case directly to the part/element that is to be coated, as is carried out preferably in the case of field joints. Alternatively, coating may also take place indirectly, with the coating being separately produced and then applied to the element to be insulated, by means of screw connection, for example. This version is implemented preferably in the case of bend restrictors and insulation covers (such as X-trees—Christmas trees and pipe insulation, for example).

Examples of other parts and devices in the offshore sector are generators, pumps, and buoys. An offshore pipe is a pipe which serves for conveying oil and gas. In this context, the oil/gas is conveyed from the seafloor to platforms, into boats/tankers, or else directly onto land. Sockets are the connections between two pipes or pipe parts. The parts and devices or elements in the offshore sector are in virtually continuous contact with seawater. As well as use for insulating articles which serve to convey oil and gas, there are further offshore applications as well, such as, for instance, the insulation of articles for the fixing and protection of offshore wind power systems and cable systems. The coated part is preferably used in seawater.

The polyurethane often adheres poorly to the parts/elements. The polyurethane is preferably cast directly onto the surface of the subsequent part/element. Typical surfaces are composed, for example, of plastics, such as epoxy resin, polypropylene, and/or metals, such as aluminum, copper, steel or iron, for example. For promoting adhesion more effectively it is possible additionally to use external adhesion promoters (adhesives, such as Cilbond from Cil or Thixon from Rohm & Haas, for instance), physical adhesion promoters (such as, for instance, electron beam coating, chemical vacuum vapor deposition, combustion of silanes, as available through the company Silicoat, for instance) or internal adhesion promoters, such as epoxysilanes, for instance.

The purpose of the examples below is to elucidate the invention in more detail.

### EXAMPLES

Starting Compounds:

C4 ether 1000 (e.g., Terathane® 1000 from Invista)

C4 ether 2000 (e.g., Terathane® 2000 from Invista)

Araldite GY 250 from Huntsman (epoxy equivalent to ISO 3001=187 g/eq epoxy, molar weight <700 g/mol)

Irganox 1135 from Ciba

Thorcat® 535: mercury phenyl neodecanoate from Thor Especialidades S.A.

Dioctyltin dimercaptide (TIB KAT 214), dibutyltin dilaurate (TIB KAT 218, DBTL), butyltin tris(2-ethylhexanoate) (TIB KAT 220) from TIB Chemicals AG

UOP-L paste (zeolite-based water scavenger from UOP)

The following products are polyether polyols based on EO/PO, from Bayer MaterialScience AG:

Acclaim® 11220 (functionality 2, OH number 10 mg KOH/g solids, 0% ethylene oxide)

Desmophen® 3218 (functionality 6, OH number 29 mg KOH/g solids, 18% ethylene oxide)

Desmophen® 201K08 (functionality 2, OH number 515 mg KOH/g solids, 0% ethylene oxide)

Desmophen® 50RE40 (functionality 6, OH number 175 mg KOH/g solids, 20% ethylene oxide)

Arcol® 1074 (functionality 3, OH number 27 mg KOH/g solids, 15% ethylene oxide)

The following products are polyisocyanates:

Desmodur® CD-S: carbodiimide/uretonimine containing 4,4′-MDI (about 25% by weight carbodiimide/uretonimine modified 4,4′-MDI and 75% by weight 4,4′-MDI; 29.5% by weight NCO content) from Bayer MaterialScience AG

Polyisocyanate 1: 50% by weight modified 4,4′-MDI based on tripropylene glycol, containing 23% by weight NCO, and 50% by weight Desmodur® CD-S, making the NCO content of the mixture 26% by weight. The crystallization point is 15° C. (after 30 days' storage).

Polyisocyanate 2: reaction product of 92.5 parts by weight of Desmodur® CD-S and 7.5 parts by weight of Desmophen 20IK08, making the NCO content 24.2% by weight. The crystallization point is -5° C. (after 30 days' storage).

Polyisocyanate 3: modified isocyanate with 26% by weight NCO content, being a reaction product of 56.1% by weight Desmodur® CD-S and 21% by weight 2,4′-MDI, and 15.3% by weight 4,4′-MDI with 7.6% by weight Desmophen 20IK08. The product does not crystallize.

Polyisocyanate 4: reaction product of 10 parts by weight of Terathane® 1000 and 90 parts by weight of Desmodur® CD-S, with an NCO content of 24.5% by weight.

### Example 1a

### Inventive

100 parts by weight of polyisocyanate 1 were reacted at about 35° C. with 129.9 parts by weight of a polyol formulation (86.2 parts by weight of Desmophen® 3218, 6.1 parts by weight of Desmophen® 50RE40, 6.1 parts by weight of Arcol® 1074, 23.1 parts by weight of 1,4-butanediol, 5.8 parts by weight of Araldite® GY 250, 0.8 part by weight of Irganox® 1135, 1.3 parts by weight of UOP-L paste, 0.5 part by weight of Thorcat® 535) and poured into a mold with a temperature of 80° C. Demolding took place after 5 minutes. The product was elastic. A coating with a Shore D hardness of 55 was obtained. This is a typical hardness for field joints and insulation covers (Christmas trees (X-trees), pipe insulation or the like). The aging in water was very good. A block of 10×10×4 cm³ was cast and was stored in water at 95° C. for 2 months. Even after 2 months under these extreme conditions, the block showed only a few small cracks.

### Example 1b

### Inventive

100 parts by weight of polyisocyanate 1 were reacted at about 35° C. with 119.4 parts by weight of a polyol formulation (76.9 parts by weight of Desmophen® 3218, 5.6 parts by weight of Desmophen® 50RE40, 5.6 parts by weight of Arcol® 1074, 23.4 parts by weight of 1,4-butanediol, 5.5 parts by weight of Araldite® GY 250, 0.7 part by weight of Irganox® 1135, 1.2 parts by weight of UOP-L paste, 0.5 part by weight of Thorcat® 535) and poured into a mold with a temperature of 80° C. Demolding took place after 5 minutes. The product was elastic. A coating with a Shore D hardness of 65 was obtained. This is a typical hardness for specialty insulation covers (as already mentioned in example 1), with a high tensile modulus. The aging in water was very good. A block of 10×10×4 cm³ was cast and was stored in water at 95° C. for 2 months. Even after 2 months under these extreme conditions, the block showed only a few small cracks.

### Example 2

### Inventive

100 parts by weight of polyisocyanate 1 were reacted at about 35° C. with 129.4 parts by weight of a polyol formulation (86.2 parts by weight of Desmophen® 3218, 6.1 parts by weight of Desmophen® 50RE40, 6.1 parts by weight of Arcol® 1074, 23.1 parts by weight of 1,4-butanediol, 5.8 parts by weight of Araldite® GY 250, 0.8 part by weight of Irganox® 1135, 1.3 parts by weight of UOP-L paste, 0.0054 part by weight of TIB KAT 214) and poured into a mold with a temperature of 80° C. Demolding took place after 5 minutes. The product was elastic. A coating with a Shore D hardness of 56 was obtained. This is a typical hardness for field joints and insulation covers (Christmas trees (X-trees), pipe insulation or the like). The aging in water was very good.

### Example 3

### Inventive

100 parts by weight of polyisocyanate 1 were reacted at about 35° C. with 129.4 parts by weight of a polyol formulation (86.2 parts by weight of Desmophen® 3218, 6.1 parts by weight of Desmophen® 50RE40, 6.1 parts by weight of Arcol® 1074, 23.1 parts by weight of 1,4-butanediol, 5.8 parts by weight of Araldite® GY 250, 0.8 part by weight of Irganox® 1135, 1.3 parts by weight of UOP-L paste, 0.0025 part by weight of DBTL) and poured into a mold with a temperature of 80° C. Demolding took place after 5 minutes. The product was elastic. A coating with a Shore D hardness of 55 was obtained. This is a typical hardness for field joints and insulation covers (Christmas trees (X-trees), pipe insulation or the like). The aging in water was very good.

### Example 4

### Inventive

100 parts by weight of polyisocyanate 1 were reacted at about 35° C. with 129.4 parts by weight of a polyol formulation (86.2 parts by weight of Desmophen® 3218, 6.1 parts by weight of Desmophen® 50RE40, 6.1 parts by weight of Arcol® 1074, 23.1 parts by weight of 1,4-butanediol, 5.8 parts by weight of Araldite® GY 250, 0.8 part by weight of Irganox® 1135, 1.3 parts by weight of UOP-L paste, 0.016 part by weight of TIB KAT 220) and poured into a mold with a temperature of 80° C. Demolding took place after 5 minutes. The product was elastic. A coating with a Shore D hardness of 55 was obtained. This is a typical hardness for field joints and insulation covers (Christmas trees (X-trees), pipe insulation or the like). The aging in water was very good.

### Example 5

### Inventive

100 parts by weight of polyisocyanate 1 were reacted at about 35° C. with 120.7 parts by weight of a polyol formulation (79.3 parts by weight of Desmophen® 3218, 10.2 parts by weight of Terathane® 2000, 23.8 parts by weight of 1,4-butanediol, 5.1 parts by weight of Araldite® GY 250, 0.7 part by weight of Irganox® 1135, 1.1 parts by weight of UOP-L paste, 0.5 part by weight of Thorcat® 535) and poured into a mold with a temperature of 80° C. Demolding took place after 5 minutes. The product was elastic. A coating with a Shore D hardness of 57 was obtained. This is a typical hardness for field joints and insulation covers (Christmas trees, pipe insulation). The aging in water was very good. A block of 10×10×4 cm³ was cast and was stored in water at 95° C. for 2 months. Even after 2 months under these extreme conditions, the block showed only a few small cracks.

### Example 6a

### Inventive

100 parts by weight of polyisocyanate 2 were reacted at about 35° C. with 122 parts by weight of a polyol formulation (81.3 parts by weight of Desmophen® 3218, 5.7 parts by weight of Desmophen® 50RE40, 5.7 parts by weight of Arcol® 1074, 21.8 parts by weight of 1,4-butanediol, 5.2 parts by weight of Araldite® GY 250, 0.7 part by weight of Irganox® 1135, 1.1 parts by weight of UOP-L paste, 0.5 part by weight of Thorcat® 535) and poured into a mold with a temperature of 80° C. Demolding took place after 5 minutes. The product was elastic. A coating with a Shore D hardness of 55 was obtained. This is a typical hardness for field joints and insulation covers (Christmas trees (X-trees), pipe insulation or the like). The aging in water was very good.

### Example 6b

### Inventive

100 parts by weight of polyisocyanate 2 were reacted at about 35° C. with 121.5 parts by weight of a polyol formulation (81.3 parts by weight of Desmophen® 3218, 5.7 parts by weight of Desmophen® 50RE40, 5.7 parts by weight of Arcol® 1074, 21.8 parts by weight of 1,4-butanediol, 5.2 parts by weight of Araldite® GY 250, 0.7 part by weight of Irganox® 1135, 1.1 parts by weight of UOP-L paste, 0.003 part by weight of DBTL) and poured into a mold with a temperature of 80° C. Demolding took place after 5 minutes. The product was elastic. A coating with a Shore D hardness of 55 was obtained. This is a typical hardness for field joints and insulation covers (Christmas trees (X-trees), pipe insulation or the like). The aging in water was very good.

### Example 7

### Not Inventive

100 parts by weight of polyisocyanate 1 were reacted at about 35° C. with 109.1 parts by weight of a polyol formulation (80 parts by weight of Terathane 2000, 22.86 parts by weight of 1,4-butanediol, 6 parts by weight of Araldite® GY 250, and 0.25 part by weight of Thorcat 535) and poured into a mold with a temperature of 80° C. Demolding took place after 5 minutes. A coating with a Shore D hardness of 57 was obtained. This is a typical hardness for field joints and insulation covers (Christmas trees, pipe insulation). However, the product exhibited excessive evolution of heat during production, and hence the product was not utilizable technically. The aging in water was inadequate.

### Example 8

### Not Inventive

100 parts by weight of polyisocyanate 1 were reacted at about 35° C. with 103.1 parts by weight of a polyol formulation (80 parts by weight of Terathane® 2000, 22.86 parts by weight of 1,4-butanediol, and 0.25 part by weight of Thorcat 535) and poured into a mold with a temperature of 80° C. Demolding took place after 5 minutes. A coating with a Shore D hardness of 57 was obtained. This is a typical hardness for field joints and insulation covers (Christmas trees, pipe insulation). However, the product exhibited excessive evolution of heat during production, and hence the product was not utilizable technically. The aging in water was also inadequate.

### Example 9

### Not Inventive

100 parts by weight of polyisocyanate 1 were reacted at about 35° C. with 95.2 parts by weight of a polyol formulation (67.5 parts by weight of Desmophen® 50RE40, 4.4 parts by weight of Arcol® 1074, 16.9 parts by weight of 1,4-butanediol, 4.3 parts by weight of Araldite® GY 250, 0.6 part by weight of Irganox® 1135, 1.0 part by weight of UOP-L paste, 0.5 part by weight of Thorcat® 535) and poured into a mold with a temperature of 80° C. The product gave off a large amount of heat during production. It was demoldable only in the cold state, since at high temperatures it was much too soft. The product is therefore unusable for the application. Further analysis was not possible, and the test specimen was discarded.

### Example 10

### Not Inventive

100 parts by weight of polyisocyanate 1 were reacted at about 35° C. with 117.9 parts by weight of a polyol formulation (90 parts by weight of Arcol® 1074, 24.5 parts by weight of 1,4-butanediol, and 3.43 parts by weight of Araldite® GY 250 and 0.005 part by weight of DBTL) and poured into a mold with a temperature of 80° C. Demolding took place after 5 minutes. A coating having a Shore D hardness of 57 was obtained. The aging in water was inadequate.

### Example 11

### Not Inventive

100 parts by weight of polyisocyanate 1 were reacted at about 35° C. with 134.42 parts by weight of a polyol formulation (40 parts by weight of Acclaim® 11220, 60 parts by weight of Arcol® 1074, 24.9 parts by weight of 1,4-butanediol, and 6.87 parts by weight of Araldite® GY 250, 1.15 parts by weight of Irganox® 1135, and 1.5 parts by weight of Thorcat® 535) and poured into a mold with a temperature of 80° C. Demolding took place after 5 minutes. A coating having a Shore D hardness of 60 was obtained. The aging in water was inadequate.

### Example 12

### Not Inventive

100 parts by weight of polyisocyanate 3 were reacted at about 35° C. with 114.5 parts by weight of a polyol formulation (90 parts by weight of Arcol® 1074, 24.5 parts by weight of 1,4-butanediol, and 0.038 part by weight of DBTL) and poured into a mold with a temperature of 80° C. Demolding took place after 5 minutes. A coating having a Shore D hardness of 62 was obtained. The aging in water was inadequate.

### Example 13

### Not Inventive

100 parts by weight of polyisocyanate 1 were reacted at about 35° C. with 114.5 parts by weight of a polyol formulation (90 parts by weight of Arcol® 1074, 24.5 parts by weight of 1,4-butanediol, and 0.038 part by weight of DBTL) and poured into a mold with a temperature of 80° C. Demolding took place after 5 minutes. A coating having a Shore D hardness of 57 was obtained. The aging in water was significantly poorer than in example 12.

### Example 14

### Not Inventive

100 parts by weight of polyisocyanate 1 were reacted at about 35° C. with 550.7 parts by weight of a polyol formulation (366.3 parts by weight of Desmophen 3218, 123.5 parts by weight of Desmophen® 50RE40, 25.8 parts by weight of Arcol® 1074, 24.5 parts by weight of Araldite® GY 250, 4.0 parts by weight of Irganox® 1135, 5.6 parts by weight of UOP-L paste, 1.0 part by weight of Thorcat® 535) and poured into a mold with a temperature of 80° C. The product only had a Shore A hardness of 50, and cracked during demolding. The elastomer was fragile and showed no structural strength. Further analysis was not possible, and the test specimen was discarded.

### Example 15

### Inventive

100 parts by weight of polyisocyanate 4 were reacted at about 35° C. with 123 parts by weight of a polyol formulation (81.2 parts by weight of Desmophen® 3218, 5.7 parts by weight of Desmophen® 50RE40, 5.7 parts by weight of Arcol® 1074, 21.7 parts by weight of 1,4-butanediol, 5.5 parts by weight of Araldite® GY 250, 0.8 part by weight of Irganox® 1135, 1.3 parts by weight of UOP-L paste, 0.001 part by weight of TIB KAT 214) and poured into a mold with a temperature of 80° C. Demolding took place after 5 minutes. The product was elastic. A coating with a Shore D hardness of 53 was obtained. This is a typical hardness for field joints and insulation covers (Christmas trees (X-trees), pipe insulation or the like). The aging in water was very good.

TABLE

| | | | Example 1a | Example 1b | Example 2 | Example 5 | Example 7 |
|---|---|---|---|---|---|---|---|
| | | | (invention) | (invention) | (invention) | (invention) | (not inventive) |
| Pot life | | [min] | 1 | 1 | 1 | 1 | 1 |
| Demolding time | | [min] | 5 | 5 | 5 | 5 | 5 |
| Hardness at 23° C. | DIN 53505 | Shore | 55 D | 64 D | 56 D | 57 D | 57 D |
| Hardness at 23° C. after 2 weeks' storage | DIN 53505 | Shore | 45 D | 50 D | 48 D | 48 D | 50 D |
| at 95° C. in water; * | | | | | | | |
| 10% modulus | DIN 53504 | [MPa] | 10.4 | 15.4 | 11.9 | 11.0 | 12.9 |
| 10% modulus after 2 weeks' storage at | DIN 53504 | [MPa] | 6.6 | 9.2 | 6.8 | 7.8 | 12 |
| 95° C. in water; * | | | | | | | |
| 100% modulus | DIN 53504 | [MPa] | 20 | 22.5 | 21.3 | 20.2 | 19.7 |
| 100% modulus after 2 weeks' storage at | DIN 53504 | [MPa] | 11.8 | 13.2 | 16.3 | 12.4 | — |
| 95° C. in water; * | | | | | | | |
| Relative modulus at 100% | | | 0.59 | 0.59 | 0.77 | 0.61 | destroyed |
| Tensile strain at break | DIN 53504 | [MPa] | 25 | 26 | 26 | 25 | 24 |
| Tensile strain at break after 2 weeks' | DIN 53504 | [MPa] | 14 | 14 | 23 | 14 | 12 |
| storage at 95° C. in water; * | | | | | | | |
| Relative tensile strain at break | | | 0.56 | 0.54 | 0.88 | 0.56 | 0.5 |
| Elongation at break | DIN 53504 | [%] | 170 | 142 | 150 | 190 | 210 |
| Elongation at break after 2 weeks' | DIN 53504 | [%] | 230 | 165 | 173 | 250 | 106 |
| storage at 95° C. in water; * | | | | | | | |
| Relative elongation at break | | | 1.35 | 1.16 | 1.15 | 1.32 | 0.5 |
| Water absorption after 2 weeks in hot | based on | [% by | 2.4 | 2.4 | 2.4 | 2.0 | 1.1 |
| water at 95° C.; * and ** | ISO 62 | weight] | | | | | |

| | | | Example 3 | Example 8 | Example 10 | Example 11 | Example 12 |
|---|---|---|---|---|---|---|---|
| | | | (inventive) | (not inventive) | (not inventive) | (not inventive) | (not inventive) |
| Pot life | | [min] | 1 | 1 | 1 | 1 | 1 |
| Demolding time | | [min] | 5 | 5 | 5 | 5 | 5 |
| Hardness at 23° C. | DIN 53505 | Shore | 55 D | 57 D | 57 D | 60 D | 62 D |
| Hardness at 23° C. after 2 weeks' storage | DIN 53505 | Shore | 45 D | 45 D | 45 D | destroyed | 41 D |
| at 95° C. in water; * | | | | | | | |
| 10% modulus | DIN 53504 | [MPa] | 11.6 | 13.2 | 10.9 | 14.8 | 15.5 |
| 10% modulus after 2 weeks' storage at | DIN 53504 | [MPa] | 6.3 | 7.8 | 7.2 | destroyed | 7 |
| 95° C. in water; * | | | | | | | |
| 100% modulus | DIN 53504 | [MPa] | 20.7 | 20.9 | 19.1 | 16.8 | 17.4 |
| 100% modulus after 2 weeks' storage at | DIN 53504 | [MPa] | 16.6 | — | 10.4 | destroyed | 8.6 |
| 95° C. in water; * | | | | | | | |
| Relative modulus at 100% | | | 0.80 | destroyed | 0.54 | destroyed | 0.49 |
| Tensile strain at break | DIN 53504 | [MPa] | 25 | 31 | 22 | 21 | 24 |
| Tensile strain at break after 2 weeks' | DIN 53504 | [MPa] | 23 | 11 | 11 | destroyed | 9 |
| storage at 95° C. in water; * | | | | | | | |
| Relative tensile strain at break | | | 0.92 | 0.35 | 0.50 | destroyed | 0.38 |
| Elongation at break | DIN 53504 | [%] | 173 | 335 | 220 | 238 | 265 |
| Elongation at break after 2 weeks' | DIN 53504 | [%] | 173 | 82 | 106 | destroyed | 220 |
| storage at 95° C. in water; * | | | | | | | |
| Relative elongation at break | | | 1.0 | 0.24 | 0.48 | destroyed | 0.83 |
| Water absorption after 2 weeks in hot | based on | [% by | 2.4 | 1.3 | 2.7 | destroyed | 2.7 |
| water at 95° C.; * and ** | ISO 62 | weight] | | | | | |

| | | | Example 4 | Example 13 | Example 6a | Example 6b | Example 15 |
|---|---|---|---|---|---|---|---|
| | | | (inventive) | (not inventive) | (inventive) | (inventive) | (inventive) |
| Pot life | | [min] | 1 | 1 | 1 | 1 | 1 |
| Demolding time | | [min] | 5 | 5 | 5 | 5 | 5 |
| Hardness at 23° C. | DIN 53505 | Shore | 55 D | 57 D | 58 D | 55 D | 53 D |
| Hardness at 23° C. after 2 weeks' storage | DIN 53505 | Shore | 48 | 40 D | 41 D | 45 D | 43 D |
| at 95° C. in water; * | | | | | | | |
| 10% modulus | DIN 53504 | [MPa] | 9.2 | 13.5 | 13.7 | 9.4 | 8.2 |
| 10% modulus after 2 weeks' storage at | DIN 53504 | [MPa] | 7 | 5.3 | 4.7 | 5.7 | 5 |
| 95° C. in water; * | | | | | | | |
| 100% modulus | DIN 53504 | [MPa] | 18.8 | 17.6 | 21.5 | 22 | 18.8 |
| 100% modulus after 2 weeks' storage at | DIN 53504 | [MPa] | 15.4 | 7.9 | 15.6 | 13.1 | 13.3 |
| 95° C. in water; * | | | | | | | |
| Relative modulus at 100% | | | 0.82 | 0.45 | 0.73 | 0.6 | 0.71 |
| Tensile strain at break | DIN 53504 | [MPa] | 24 | 22 | 24 | 24 | 19 |
| Tensile strain at break after 2 weeks' | DIN 53504 | [MPa] | 21 | 9.9 | 20 | 16 | 15 |
| storage at 95° C. in water; * | | | | | | | |
| Relative tensile strain at break | | | 0.88 | 0.45 | 0.83 | 0.67 | 0.79 |
| Elongation at break | DIN 53504 | [%] | 166 | 235 | 137 | 125 | 104 |
| Elongation at break after 2 weeks' | DIN 53504 | [%] | 175 | 220 | 169 | 180 | 128 |
| storage at 95° C. in water; * | | | | | | | |
| Relative elongation at break | | | 1.05 | 0.94 | 1.23 | 1.44 | 123 |
| Water absorption after 2 weeks in hot | based on | [% by | 2.3 | 2.8 | 2.3 | 2.3 | 2.3 |
| water at 95° C.; * and ** | ISO 62 | weight] | | | | | |

* The samples were stored before the test for 24 hours at 23° C. (60% humidity). Mains water was used.
** The samples were taken from the water, the adhering water was removed with a cloth, and measurement took place immediately.

In addition to the temperature aging, the water aging also influences the properties of the products. In the course of an aging test in water, an elastomer may be decomposed/destroyed by hydrolysis, and may also be swollen. Particularly meaningful in relation to any hydrolysis occurring are the moduli at 100%, the elongation at break, and the tensile strain at break, and so these properties are measured in particular on the elastomers produced.

From the tables it is clearly evident that the inventive elastomers have better—that is, higher—relative moduli at 100%, higher relative elongations at break, and better relative tensile strains at break. The relative values were calculated arithmetically, with the respective value after storage in water being divided by the respective value before storage in water. The relative values permit a better comparison of the various elastomers.

1. Coated part coated directly or indirectly with polyurethane,wherein the polyurethane,
in the presence of at least one metal catalyst from the group consisting of mercury, cadmium, cobalt, hafnium, aluminum, lead, iron, tin, zinc, bismuth, zirconium, and titanium catalysts, and blends thereof, being is obtainable from:
a) at least one polyisocyanate based on diphenylmethane diisocyanate (MDI) and having an NCO content of 18% to 34% by weight, a fraction of not more than 20% by weight, based on polyisocyanate a) employed, of 2,4′-MDI isomer and a fraction of at least 5% by weight, based on polyisocyanate a) employed, of diphenylmethane diisocyanate modified with carbodiimide groups and with uretonimine groups, and being liquid above 30° C.,
b) at least one ethylene oxide and/or propylene oxide based polyether polyol having a functionality of 5 to 8, preferably of 6 to 7, an OH number of 5 to 45 mg KOH/g solids, and an ethylene oxide units content of 0% to 50% by weight,
c) at least one chain extender having a molecular weight of 62 to 500 g/mol and a functionality of 2 to 3,
d) 2% to 15% by weight, based on components b) to e), of at least one epoxy resin having a number-average molecular weight of 10 000 g/mol,
e) 0% to 50% by weight, based on components b) to e), of at least one polyol selected from the group consisting of ethylene oxide and/or propylene oxide based polyethers having an OH number of 50 to 400 mg KOH/g solids, a functionality of 5 to 7, and an ethylene oxide units content of 0% to 50% by weight, ethylene oxide and/or propylene oxide based polyethers having an OH number of 20 to 200 mg KOH/g solids, a functionality of ≧2 to <5, and an ethylene oxide units content of 0% to 50% by weight, polyols having a functionality of 2 and based on polytetramethylene glycols having a molecular weight of 600 to 3000 g/mol, OH-terminated polybutanedienes, polycarbonate diols, and blends thereof,
f) optionally UV stabilizers and oxidation stabilizers,
g) optionally auxiliaries and/or additives, and
h) optionally adhesion promoters,
wherein the ratio of NCO groups to NCO-reactive groups in components b), c), and e) being from 0.70:1 to 1.3:1, optionally from 0.85:1 to 1.2:1.
